(19) United States
(12) Patent Application Publication
(10) Pub. No.: US 2026/0028467 A1
(43) Pub. Date: Jan. 29, 2026

(54) POLYMERIZATION INHIBITORS FOR HIGH TEMPERATURE ETHYLENE FRACTIONATION TRAINS

(71) Applicant: BL TECHNOLOGIES, INC., Minnetonka, MN (US)

(72) Inventors: Bryan Crom, Minnetonka, MN (US); David Hood, Minnetonka, MN (US); Nimeshkumar Patel, Minnetonka, MN (US)

(21) Appl. No.: 18/996,835

(22) PCT Filed: Aug. 30, 2023
(86) PCT No.: PCT/US2023/073169

§ 371 Date: Jan. 17, 2025

Related U.S. Application Data
(60) Provisional application No. 63/408,061, filed on Sep. 19, 2022.

(51) Int. Cl. C08K 5/07

(52) U.S. Cl. CPC C08K 5/07

(57) ABSTRACT

A method for inhibiting polymerization, gum formation and fouling of an atypical, high temperature ethylene fractionation train comprising treating the atypical, high temperature ethylene fractionation train with a composition including effective amounts of one or more quinone methides of the formula:

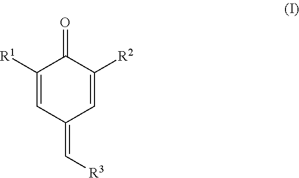

wherein R¹, R², and R³ are independently selected from the group consisting of H, —OH, —SH, —NH2, alkyl, cycloalkyl, heterocyclo, and aryl; or one or more phenylene diamines, optionally, in combination with one or more hindered phenols.

### CROSS-REFERENCE TO RELATED APPLICATIONS

This application claims the priority benefit of Application Ser. No. 63/408,061 filed Sep. 19, 2022, the entirety of which is herein incorporated by reference.

### FIELD

The disclosed technology relates to compositions and methods for inhibiting polymerization, gum formation and fouling in ethylene fractionation trains. More specifically, the disclosed technology relates to methods of inhibiting polymerization, gum formation and fouling in high temperature ethylene fractionation trains that include treating the high temperature ethylene fractionation trains with high temperature-stable antifoulant and/or antipolymerant compositions including quinone methides and/or phenylene diamines.

### BACKGROUND

Undesired polymerization, also called gum formation, can occur in the light ends fractionation train of an ethylene plant, causing fouling that will negatively impact heat transfer efficiencies, fluid flows, and product yields, and potentially lead to generation of highly prolific “popcorn polymer.” Most units can be treated effectively with traditional inhibitor chemistries such as 4-hydroxyTEMPO (or other stable free radical chemistries), n,n-diethylhydroxylamine (or other hydroxylamines), butylated hydroxy toluene (or other phenolic antioxidants), and combinations thereof.

Some units, however, are operated at higher than typical temperature regimes. These units cannot be treated with a traditional inhibitor approach due to the lack of effectiveness of these traditional actives. A different approach for inhibiting polymerization, gum formation and fouling in these atypical units is needed.

### SUMMARY

The disclosed technology provides for inhibiting polymerization, gum formation and fouling in ethylene fractionation trains using high temperature-stable antifoulant and/or antipolymerant compositions including quinone methides and/or phenylene diamines.

Various aspects of the disclosure relate to a high temperature-stable composition for inhibiting polymerization in a high temperature ethylene fractionation train comprising:
an effective amount of one or more quinone methides of the formula:

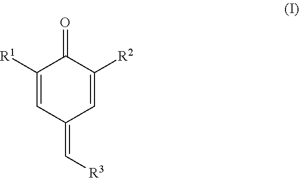

wherein R¹, R², and R³ are independently selected from the group consisting of H, —OH, —SH, —NH₂, alkyl, cycloalkyl, heterocyclo, and aryl; and an effective amount of one or more phenylene diamines, such as an asymmetrical phenylene diamine.

In various aspects, the high temperature-stable antifoulant or antipolymerant composition further comprises one or more hindered phenols.

Various aspects of the disclosure additionally relate to a method of inhibiting polymerization in an ethylene fractionation train comprising adding an effective amount of one or more quinone methides of the formula:

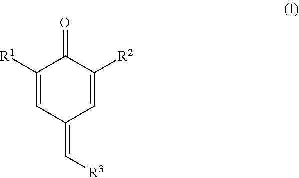

wherein R¹, R², and R³ are independently selected from the group consisting of H, —OH, —SH, —NH₂, alkyl, cycloalkyl, heterocyclo-, and aryl.

In various aspects of the disclosed method, the method further comprises adding an effective amount of one or more phenylene diamines.

In various aspects of the disclosed method, the method further comprises adding an effective amount of one or more hindered phenols.

Various aspects of the disclosure further relate to a method of inhibiting gum formation and fouling in a high temperature ethylene fractionation train comprising: adding an effective amount of one or more quinone methides of the formula:

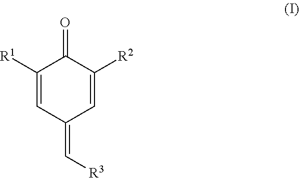

wherein R¹, R², and R³ are independently selected from the group consisting of H, —OH, —SH, —NH₂, alkyl, cycloalkyl, heterocyclo, and aryl.

In various aspects of the disclosed method, the method further comprises adding an effective amount of one or more phenylene diamines.

In various aspects of the disclosed method, the method further comprises adding an effective amount of one or more hindered phenols.

### BRIEF DESCRIPTION OF THE FIGURES

Those of skill in the art will understand that the figures, described below, are for illustrative purposes only. The figures are not intended to limit the scope of the present teachings in any way.

FIG. 1 illustrates the reduction in gum formation in a liquid sample derived from a synthetic matrix consisting of 50% isoprene and 50% n-heptane after treatment with a 20 ppm dose of various polymerization inhibitor chemistries, including various embodiments of the compositions of the disclosed technology.

FIGS. 2A-2C illustrate the reduction in gum formation in a liquid sample derived from a synthetic matrix consisting of 50% isoprene and 50% n-heptane after treatment with 20 ppm of various polymerization inhibitor chemistries, including various heat-stressed and non-heat stressed embodiments of the compositions of the disclosed technology, and under N₂ purged (O₂ fully removed) and N₂ blanket (dissolved O₂ remains) conditions.

FIG. 3 illustrates the reduction in gum formation in a liquid sample derived from a synthetic matrix consisting of 50% isoprene and 50% n-heptane after treatment with 10 ppm or 20 ppm of various polymerization inhibitor chemistries, including various embodiments of the compositions of the disclosed technology.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

The disclosed technology provides for compositions and methods for inhibiting polymerization, gum formation and fouling in ethylene fractionation trains, wherein the compositions comprise quinone methides and/or phenylene diamines.

The compositions and methods disclosed herein have been found to be effective in reducing undesirable polymerization, gum formation and fouling in ethylene fractionation trains. More specifically, the compositions and methods disclosed herein have been found to be effective in reducing undesirable polymerization, gum formation and fouling in atypical, high temperature, ethylene fractionation trains through the application of high temperature stable active agents, such as quinone methides and/or phenylene diamines, optionally in combination with hindered phenols. Without being bound by theory, it is believed that the addition of one or more high temperature stable actives to the atypical, high temperature, ethylene fractionation trains inhibits free radical polymerization. It is believed that quinone methide actives may react with any thermally generated carbon-centered free radicals, while the phenylene diamine actives may interact with thermally generated oxygen centered free radicals, and/or terminate alkyl radicals in the trains. It is further believed that the optional hindered phenol active may boost the reaction rate of the quinone methide actives with the carbon-centered free radicals.

As used herein, the term “ethylene fractionation train” refers to a section of an ethylene plant including one or more fractionators.

As used herein, the term “high temperature ethylene fractionation train” refers to ethylene fractionation trains that operate at higher temperatures, such as between about 120° C. to 160° C.

As used herein, the term “an effective amount” refers to any amount of a high temperature-stable active agent that is effective in inhibiting polymerization, gum formation and fouling in an ethylene fractionation train.

In various aspects of the disclosed technology, a high-temperature stable composition for inhibiting polymerization, gum formation and fouling in an ethylene fractionation train is disclosed. In various aspects, the high-temperature stable composition may include an effective amount of one or more high temperature-stable active agents. In some aspects, the high temperature-stable composition may include an amount of any high temperature-stable active agent that is effective in inhibiting polymerization, gum formation and fouling in an ethylene fractionation train. In other aspects, the high temperature-stable active agent may include any active agent that is effective in inhibiting free radical polymerization in high temperature ethylene fractionation trains.

In various aspects, suitable high-temperature stable active agents may include quinone methides of the formula (I):

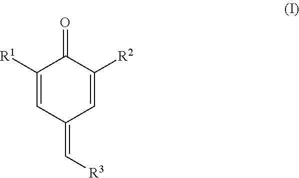

wherein R¹, R², and R³ are independently selected from the group consisting of H, —OH, —SH, —NH₂, alkyl, cycloalkyl, heterocyclo, and aryls; alkyl-(3,5-di-tert-butyl-4-oxocyclohexane-2,5-dienylidene)-cyano derivatives of quinone methide; alkyl-(3,5-di-tert-butyl-4-oxocyclohexane-2,5-dienylidene)-acid derivatives of quinone methide; alkyl-(3,5-di-tert-butyl-4-oxocyclohexane-2,5-dienylidene)-ester derivatives of quinone methide; 2,6-di-tertbutyl-4-(4-nitrobenzylidene)-cyclohexa-2,5-dienone; di-tert-butyl-3-(4-nitrobenzylidene)-cyclohexa-2,5-dienone; 2,6-di-tert-butyl-4-(4-cyanobenzylidene)-cyclohexa-2,5-dienone; 2,6-di-tert-butyl-4-(4-methoxybenzylidene)-cyclohexa-2,5-dienone; 2,6-di-tert-butyl-4-(3,5-di-tert-butyl-4-hydroxybenzylidene)-cyclohexa-2,5-dienone; 2-(3,5-Ditert-butyl-4-oxocyclohexa-2,5-dien-1-ylidene)acetonitrile; 2,6-di-tert-butyl-4-(methoxymethylene)cyclohexa-2,5-dienone; phenylene diamines; hindered phenols; and combinations thereof.

In various aspects, the high temperature-stable composition may comprise one or more quinone methides of the formula (I) and one or more phenylene diamines.

In various aspects, the high temperature-stable composition may comprise one or more quinone methides of the formula (I), one or more phenylene diamines, and one or more hindered phenols.

In various aspects, suitable quinone methides may include 4-benzylidene-2,6-di-tert-butyl-cyclohexa-2,5-dienone of formula (II):

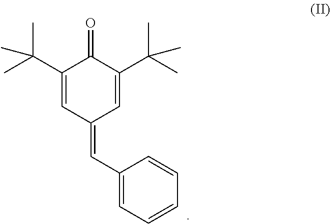 [SMILES: CC(C)(C)C1=CC(=Cc2ccccc2)C=C(C(C)(C)C)C1=O]

In various aspects, suitable phenylene diamines may include asymmetrical phenylene diamines such as N-(1,4-dimethylpentyl)-N-phenyl-p-phenylenediamine, N-(1,3-dimethylbutyl)-N′-phenyl-p-phenylenediamine, or combinations thereof.

In various aspects, suitable hindered phenols may include 2,6-di-tert-butyl phenol, butylated hydroxy toluene; butylated hydroxy anisole; 2,4,6-Tri-tertiary-butylphenol; 4,4′-Methylenebis[2,6-bis(2-methyl-2-propanyl)phenol]; or combinations thereof.

In various aspects, the high temperature-stable active agents may be present in the composition in an amount of between about 0.1 ppm to about 10000 ppm, or about 0.1, 0.2, 0.3, 0.4, 0.5, 0.6, 0.7, 0.8, 0.9, 1, 5, 10, 20, 30, 40, 50, 60, 70, 80, 90, 100, 150, 200, 250, 300, 350, 400, 450, 500, 550, 600, 650, 700, 750, 800, 850, 900, 950, 1000, 2000, 3000, 4000, 5000, 6000, 7000, 8000, 9000 or 10000 ppm, or between about 0.1 ppm to about 50 ppm or between about 20 ppm to about 40 ppm, or any amount between any of these values.

In various aspects, the high temperature-stable composition may comprise the one or more quinone methides of formula (I) and the one or more phenylene diamines in a ratio of between about 1:1 to 1:100, or 1:1, 1:2, 1:4, 1:6, 1:8, 1:10, 1:20, 1:30, 1:40, 1:50, 1:60, 1:70, 1:80, 1:90, or 1:100, or between about 1:2 to 1:10; or any ratio in between any of these ratios.

In various aspects, the high temperature-stable active agents of the disclosed technology may be used in a method of inhibiting polymerization in an ethylene fractionation train. In various aspects, the high temperature-stable active agents may further be used in a method of inhibiting gum formation and fouling in a high temperature ethylene fractionation train. In various aspects, the method may include adding to the ethylene fractionation train an effective amount of the one or more high temperature-stable active agents.

In various aspects, the methods may include adding to the ethylene fractionation train an effective amount of one or more quinone methides selected from quinone methides of the formula (I):

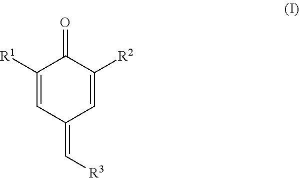

wherein R¹, R², and R³ are independently selected from the group consisting of H, —OH, —SH, —NH₂, alkyl, cycloalkyl, heterocyclo, and aryls; alkyl-(3,5-di-tert-butyl-4-oxocyclohexane-2,5-dienylidene)-cyano derivatives of quinone methide; alkyl-(3,5-di-tert-butyl-4-oxocyclohexane-2,5-dienylidene)-acid derivatives of quinone methide; alkyl-(3,5-di-tert-butyl-4-oxocyclohexane-2,5-dienylidene)-ester derivatives of quinone methide; 2,6-di-tertbutyl-4-(4-nitrobenzylidene)-cyclohexa-2,5-dienone; di-tert-butyl-3-(4-nitrobenzylidene)-cyclohexa-2,5-dienone; 2,6-di-tert-butyl-4-(4-cyanobenzylidene)-cyclohexa-2,5-dienone; 2,6-di-tert-butyl-4-(4-methoxybenzylidene)-cyclohexa-2,5-dienone; 2,6-di-tert-butyl-4-(3,5-di-tert-butyl-4-hydroxybenzylidene)-cyclohexa-2,5-dienone; 2-(3,5-Ditert-butyl-4-oxocyclohexa-2,5-dien-1-ylidene)acetonitrile; 2,6-di-tert-butyl-4-(methoxymethylene)cyclohexa-2,5-dienone; or one or more phenylene diamines; one or more hindered phenols; or combinations thereof.

In various aspects, the methods may include adding to the ethylene fractionation train an effective amount of one or more quinone methides of the formula (I), and an effective amount of one or more phenylene diamines.

In various aspects, the methods may include adding to the ethylene fractionation train an effective amount of one or more quinone methides of the formula (I), an effective amount of one or more phenylene diamines, and an effective amount of one or more hindered phenols.

In various aspects, suitable quinone methides may include 4-benzylidene-2,6-di-tert-butyl-cyclohexa-2,5-dienone of formula (II):

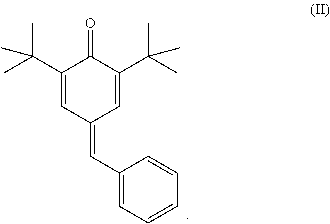 [SMILES: CC(C)(C)C1=CC(=Cc2ccccc2)C=C(C(C)(C)C)C1=O]

In various aspects, suitable phenylene diamines may include asymmetrical phenylene diamines such as N-(1,4-dimethylpentyl)-N-phenyl-p-phenylenediamine, N-(1,3-dimethylbutyl)-N′-phenyl-p-phenylenediamine, or combinations thereof.

In various aspects, suitable hindered phenols may include 2,6-di-tert-butyl phenol, butylated hydroxy toluene; butylated hydroxy anisole; 2,4,6-Tri-tertiary-butylphenol; 4,4′-Methylenebis[2,6-bis(2-methyl-2-propanyl)phenol]; or combinations thereof.

In various aspects of the methods of the disclosed technology, the high temperature-stable active agents may be added to the ethylene fractionation train in an amount of between about 0.1 ppm to about 10000 ppm, or about 0.1, 0.2, 0.3, 0.4, 0.5, 0.6, 0.7, 0.8, 0.9, 1, 5, 10, 20, 30, 40, 50, 60, 70, 80, 90, 100, 150, 200, 250, 300, 350, 400, 450, 500, 550, 600, 650, 700, 750, 800, 850, 900, 950, 1000, 2000, 3000, 4000, 5000, 6000, 7000, 8000, 9000 or 10000 ppm, or between about 0.1 ppm to about 50 ppm or between about 20 ppm to about 40 ppm, or any amount between any of these values.

In various aspects, the methods may comprise adding the one or more quinone methides of formula (I) and the one or more phenylene diamines in a ratio of between about 1:1 to 1:100, or 1:1, 1:2, 1:4, 1:6, 1:8, 1:10, 1:20, 1:30, 1:40, 1:50, 1:60, 1:70, 1:80, 1:90, or 1:100, or between about 1:2 to 1:10; or any ratio in between these ratios.

### EXAMPLES

The present technology will be further described in the following examples, which should be viewed as being illustrative and should not be construed to narrow the scope of the disclosed technology or limit the scope to any particular embodiments.

### Example 1

### Exemplary Inhibitor Chemistries:

BHT—2, 6-di-tert-butyl phenol
PDA-1—N,N′-Di-sec-butyl-p-phenylenediamine
PDA-2—N-(1,4-dimethylpentyl)-N-phenyl-p-phenylenediamine
QM-based—4-benzylidene-2,6-di-tert-butyl-cyclohexa-2,5-dienone and 2, 6-di-tert-butyl phenol.

Heat Induced Gums testing was performed on a synthetic matrix consisting of 50% isoprene (stock inhibitor removed) and 50% n-heptane. The Heat Induced Gums testing consisted of treating samples with 10 ppm or 20 ppm of the inhibitor chemistries listed above (or mixtures thereof), placing the samples in an autoclave, either blanketing or purging (3×) the samples with 400 psig nitrogen, and then placing the samples in a heated oil bath for 4 hours. The oil bath was heated to 140° C. to represent the high temperature operating conditions to be treated. After heating for 4 hours, the autoclave was cooled, vented and the liquid samples were removed.

The liquid samples were then transferred to a pre-weighed beaker and placed in a block heater. A flow of heated nitrogen was directed over the top of the liquid, with the intent of forcing the evaporation of the liquid phase. If any polymer (gums) had formed during the 4 hour heating phase, it would remain in the beaker after the liquid evaporated. After 30 minutes, the beaker was cooled and weighed. The amount of gums was then quantified in mg/100 mL.

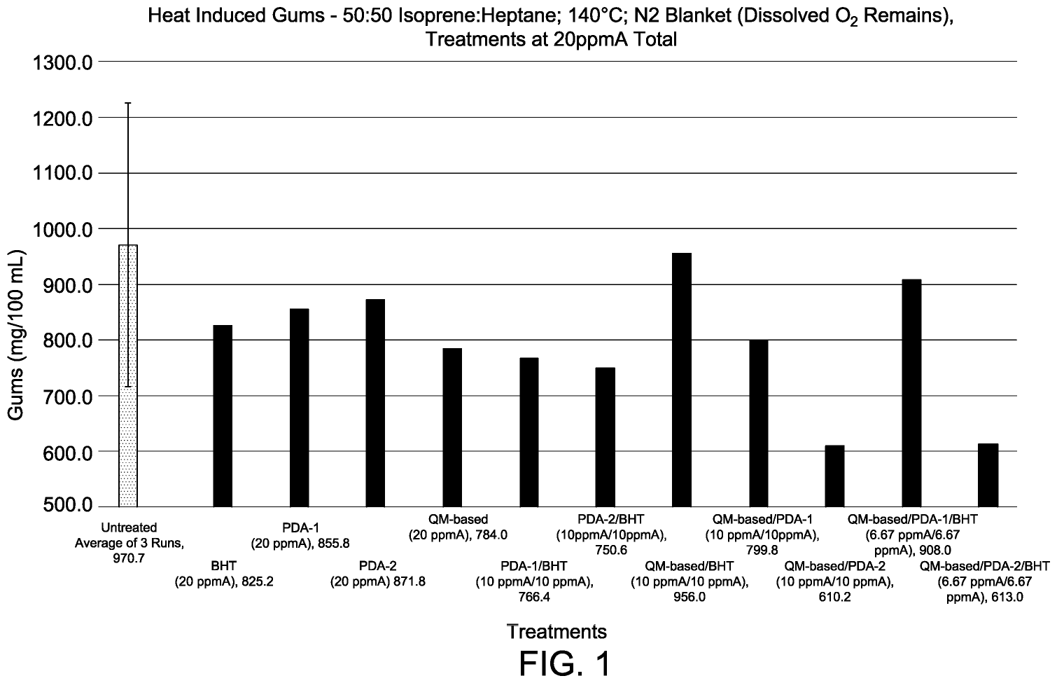

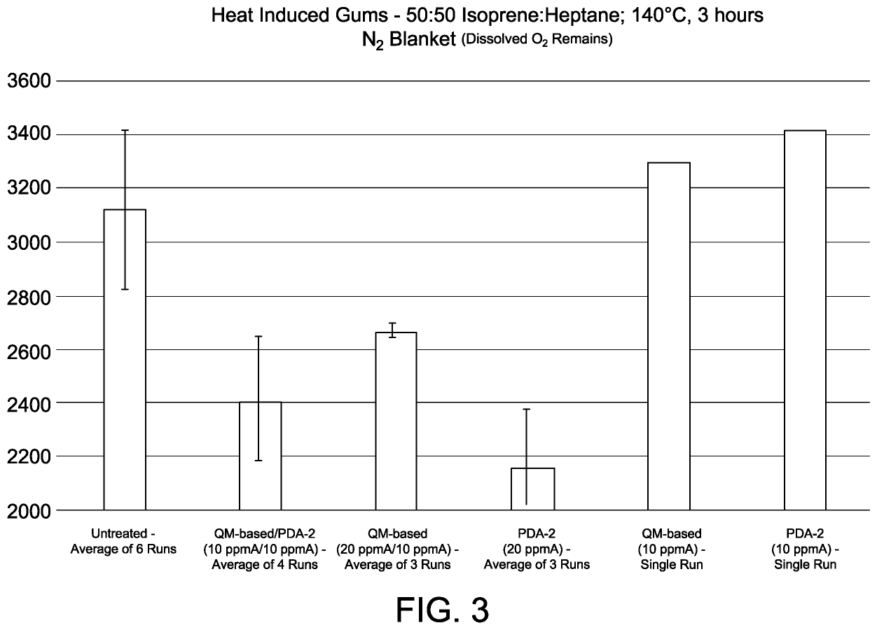

As shown in FIGS. 1 and 3, of the various inhibitor chemistries tested, addition of the QM-based/PDA-2 and QM-based/PDA-2/BHT mixtures to the sample resulted in substantially lower gum formation when compared to the untreated sample and other chemistries.

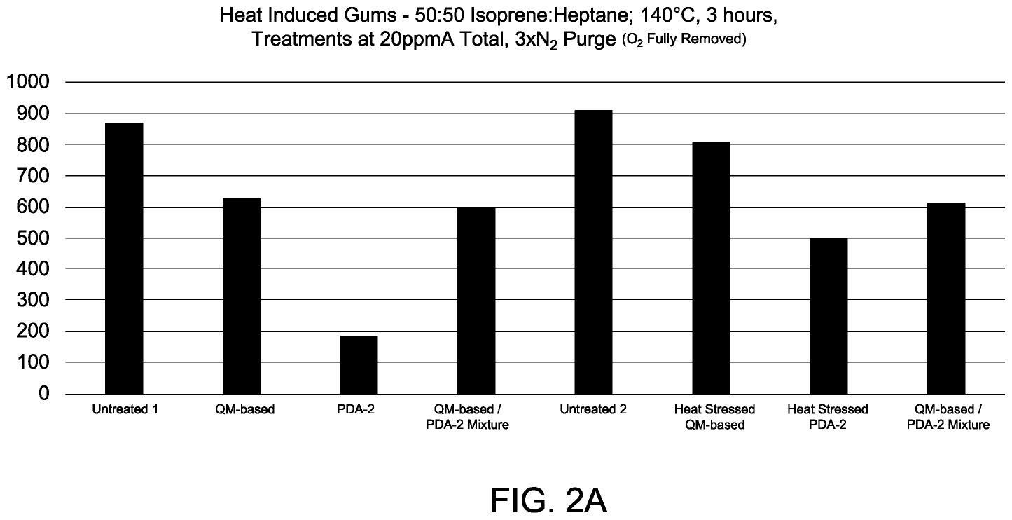

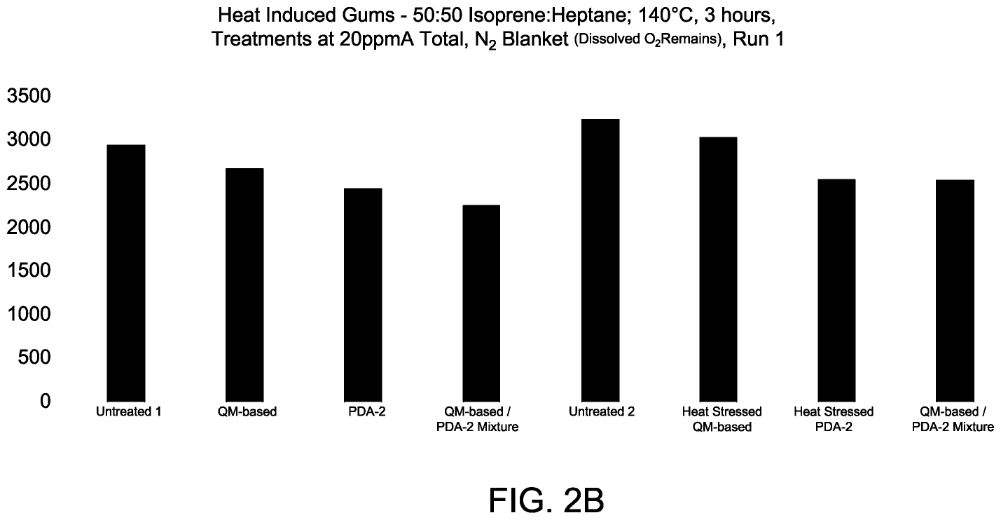

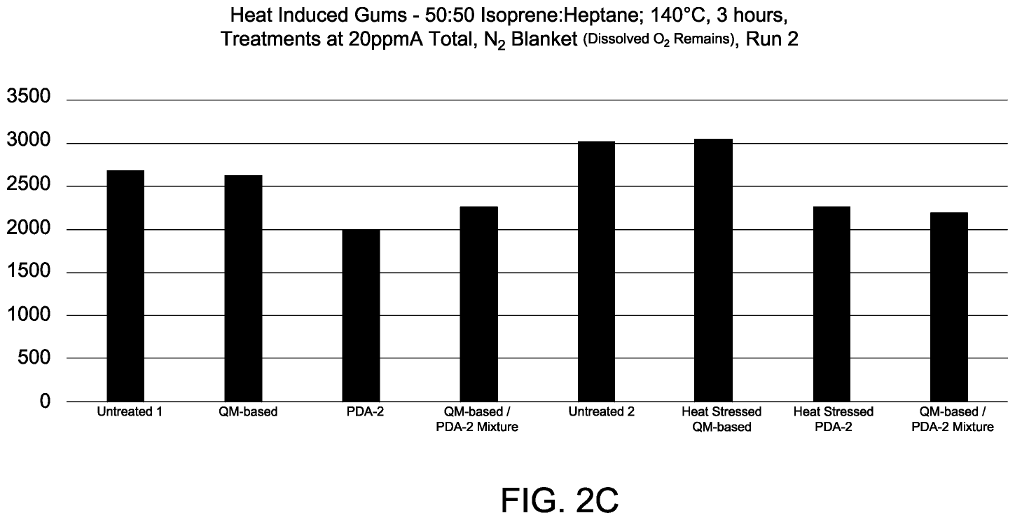

Additionally, as shown in FIGS. 2A-2C, addition of the QM-based and QM-based/PDA-2 mixtures to the sample resulted in substantially lower gum formation when compared to untreated samples, as well as heat stressed inhibitor chemistries, under both O₂-free (3×N₂ purge) and low O₂ (N₂ blanket) conditions.

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A high temperature-stable composition for inhibiting polymerization in a high temperature ethylene fractionation train comprising:
an effective amount of one or more quinone methides of the formula: 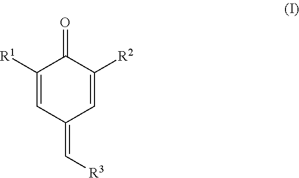
wherein R¹, R², and R³ are independently selected from the group consisting of H, —OH, —SH, —NH₂, alkyl, cycloalkyl, heterocyclo, and aryl;
an effective amount of one or more phenylene diamines; and
optionally, one or more hindered phenols.

2. (canceled)

3. The high temperature-stable composition of claim 1, wherein the one or more quinone methides comprises 4-benzylidene-2,6-di-tert-butyl-cyclohexa-2,5-dienone of formula (II):

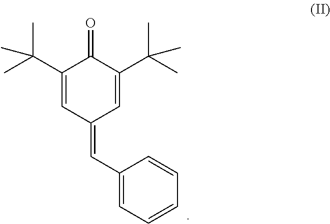 [SMILES: CC(C)(C)C1=CC(=Cc2ccccc2)C=C(C(C)(C)C)C1=O]

4. The high temperature-stable composition of claim 1, wherein the one or more phenylene diamines comprises an asymmetrical phenylene diamine.

5. The high temperature-stable composition of claim 4, wherein the asymmetrical phenylene diamine is N-(1,4-dimethylpentyl)-N-phenyl-p-phenylenediamine.

6. The high temperature-stable composition of claim 1, wherein the composition comprises one or more hindered phenols and the one or more hindered phenols comprises 2,6-di-tert-butyl phenol.

7. The high temperature-stable composition of claim 1, wherein the composition comprises at least one of: (i) the one or more quinone methides in an amount of between about 1 ppm to about 10,000 ppm; (ii) the one or more phenylene diamines in an amount of between about 1 ppm to about 10,000 ppm; and (iii) the composition comprises one or more hindered phenols in an amount of between about 0.1 ppm to about 10,000 ppm.

8-12. (canceled)

13. A method of inhibiting polymerization in an ethylene fractionation train comprising:
adding an effective amount of one or more quinone methides of the formula: 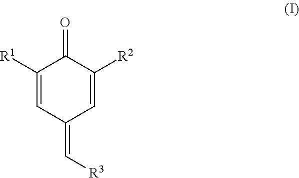
wherein R¹, R², and R³ are independently selected from the group consisting of H, —OH, —SH, —NH₂, alkyl, cycloalkyl, heterocyclo, and aryl; and
optionally, (i) adding an effective amount of one or more phenylene diamines; and/or (ii) adding an effective amount of one or more hindered phenols.

14. (canceled)

15. (canceled)

16. The method of claim 13, wherein the one or more quinone methides comprises 4-benzylidene-2,6-di-tert-butyl-cyclohexa-2,5-dienone of formula (II):

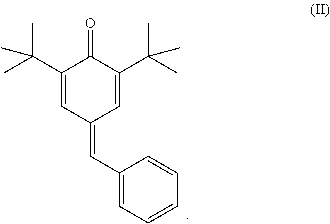 [SMILES: CC(C)(C)C1=CC(=Cc2ccccc2)C=C(C(C)(C)C)C1=O]

17. The method of claim 13, wherein the method comprises (i) adding an effective amount of one or more phenylene diamines and the one or more phenylene diamines comprises an asymmetrical phenylene diamine.

18. The method of claim 17, wherein the asymmetrical phenylene diamine is N-(1,4-dimethylpentyl)-N-phenyl-p-phenylenediamine.

19. The method of claim 13, where the method comprises (ii) adding an effective amount of one or more hindered phenols and the one or more hindered phenols comprises 2,6-di-tert-butyl phenol.

20. The method of claim 13, wherein the method comprises at least one of: (a) adding the one or more quinone methides in an amount of between about 1 ppm to about 10,000 ppm; (b) the method comprises adding an effective amount of one or more phenylene diamines in an amount of between about 1 ppm to about 10,000 ppm; and (c) the method comprises adding an effective amount of one or more hindered phenols in an amount of between about 0.1 ppm to about 10,000 ppm.

21-25. (canceled)

26. The method of claim 13, wherein the ethylene fractionation train operates at a high temperature of about 120° C. to about 160° C.

27. The method of claim 13, wherein the polymerization is free radical polymerization.

28. A method of inhibiting gum formation and fouling in a high temperature ethylene fractionation train comprising:
adding an effective amount of one or more quinone methides of the formula: 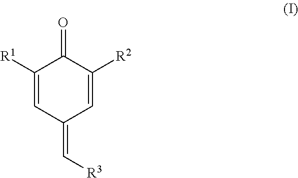
wherein R¹, R², and R³ are independently selected from the group consisting of H, —OH, —SH, —NH₂, alkyl, cycloalkyl, heterocyclo, and aryl; and
optionally, (i) adding an effective amount of one or more phenylene diamines; and/or (ii) adding an effective amount of one or more hindered phenols.

29. (canceled)

30. (canceled)

31. The method of claim 28, wherein the one or more quinone methides comprises 4-benzylidene-2,6-di-tert-butyl-cyclohexa-2,5-dienone of formula (II):

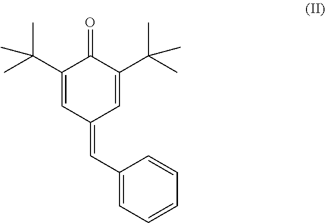 [SMILES: CC(C)(C)C1=CC(=Cc2ccccc2)C=C(C(C)(C)C)C1=O]

32. The method of claim 2, wherein the method comprises (i) adding an effective amount of one or more phenylene diamines and the one or more phenylene diamines comprises an asymmetrical phenylene diamine.

33. The method of claim 32, wherein the asymmetrical phenylene diamine is N-(1,4-dimethylpentyl)-N-phenyl-p-phenylenediamine.

34. The method of claim 28, where the method comprises (ii) adding an effective amount of one or more hindered phenols and the one or more hindered phenols comprises 2,6-di-tert-butyl phenol.

35. The method of claim 28, wherein the method comprises at least one of (a) adding the one or more quinone methides in an amount of between about 1 ppm to about 10,000 ppm; (b) the method comprises adding an effective amount of one or more phenylene diamines in an amount of between about 1 ppm to about 10,000 ppm; and (c) the method comprises adding an effective amount of one or more hindered phenols in an amount of between about 0.1 ppm to about 10,000 ppm.

36-41. (canceled)
